(19) United States
(12) Patent Application Publication
(10) Pub. No.: US 2019/0155560 A1
(43) Pub. Date: May 23, 2019

(54) MULTI-DISPLAY CONTROL APPARATUS AND METHOD THEREOF

(71) Applicants: Mindtronic AI Co.,Ltd., Grand Cayman (KY); Shanghai XPT Technology Limited, Shanghai City (CN)

(72) Inventors: Mu-Jen Huang, Taipei City (TW); Ya-Li Tai, Taoyuan City (TW); Yu-Sian Jiang, Kaohsiung City (TW); Tianle Chen, Shanghai City (CN)

(21) Appl. No.: 16/215,661

(22) Filed: Dec. 11, 2018

Related U.S. Application Data
(63) Continuation-in-part of application No. 16/198,785, filed on Nov. 22, 2018.

(30) Foreign Application Priority Data
Nov. 23, 2017 (CN) 201711185820.2
Nov. 23, 2017 (CN) 201721584752.2

(51) Int. Cl. G06F 3/14; G09G 5/00; G06F 3/01; G09G 5/26

(52) U.S. Cl. CPC G06F 3/1423; G09G 5/005; G06F 3/013; B60K 35/00; G09G 2380/10; G09G 2354/00; G09G 2340/045; G09G 5/26

(57) ABSTRACT

An apparatus for displaying a subject content to a user in a vehicle. The apparatus includes: a digital dashboard disposed in the vehicle, wherein the digital dashboard has a notification window thereon for displaying a notification to inform the user of a receipt of the subject content; and a destination display device also disposed in the vehicle, wherein, upon the user's selection, the destination display device is provided to display the subject content to the user. The font of the subject content is adjusted to fit the size of the destination display device.

### CROSS REFERENCE TO RELATED APPLICATIONS

This application is a continuation-in-part application of U.S. Pat. No. 16/198,785, which is incorporated hereinafter by reference.

### BACKGROUND OF THE INVENTION

### 1. Field of the Invention

The present invention relates to a multi-display control apparatus and method, and more particularly, to a multi-display control apparatus and method capable of moving display contents among multiple display devices according to a gaze of a user and a control command.

### 2. Description of the Prior Art

Various displaying devices are provided in vehicles, such as a digital dashboard, a head-up display, a central console display, a rear-seat display, to provide abundant information to users. Those displaying devices are nevertheless independent. The contents displayed on one individual displaying device cannot be shared on another without a dedicatedly designed equipment.

### SUMMARY OF THE INVENTION

The present invention provides a multi-display control apparatus and control method.

According to one aspect of the present disclosure, a method of displaying a subject content on multiple display devices is provided. The method includes: displaying, by a control unit, a notification on a notification window of a primary display device, wherein the subject content is embedded in the notification; determining, by a sensing module, if a user's gaze falls on the notification window; determining, by a confirmation module, if a confirmation command is issued when the user's gaze is on the notification window; determining, through the sensing module, a destination display device based on the change of the user's gaze; and displaying, through the control unit, the subject content on the destination display device.

According to another aspect of the present disclosure, an apparatus for displaying a subject content to a user in a vehicle is also provided. The apparatus includes: a digital dashboard disposed in the vehicle, wherein the digital dashboard has a notification window thereon for displaying a notification to inform the user of a receipt of the subject content; and a destination display device also disposed in the vehicle, wherein, upon the user's selection, the destination display device is provided to display the subject content to the user; wherein the font of the subject content is adjusted to fit the size of the destination display device.

According to further aspect of the present discourse, a multi-display control apparatus for displaying a subject content to a user in a vehicle having a plurality of display devices is further provided. The multi-display control apparatus includes: a primary display device having a plurality of notification windows; a destination display device; a control unit configured to display a notification on one of the notification windows, wherein the subject content is embedded in the notification; a sensing module configured to determine a gaze of the user; and wherein the control unit displays the subject content on the destination display device if the user's gaze is on the notification window and the user then changes the gaze from the primary display device to the destination display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a multi-display control apparatus according to an embodiment of the present disclosure.

FIG. 2 is a schematic diagram illustrating the operation of the multi-display control apparatus according to an embodiment of the present disclosure.

FIG. 3A is a schematic diagram of the contents displayed on a digital dashboard according to an embodiment of the present disclosure.

FIG. 3B is another schematic diagram of the contents displayed on a digital dashboard according to an embodiment of the present disclosure.

FIG. 4 is a flowchart of a method of displaying a subject content on multiple display devices according to an embodiment of the present invention.

### DETAILED DESCRIPTION

When it comes to driving, the driver of a vehicle must be concentrated and always almost keeps the eyesight straight. Important information of the vehicle are usually displayed on a dashboard disposed right in front of the driver, so that the driver can easily appreciate the information without moving his/her eyesight greatly. Modern vehicles usually equip with some sort of communication capabilities. That means a driver may pair his/her cellphone with a vehicle. Consequently, whenever, for instance, a message or an email is received, a notification may prompt to the driver on either one of the display devices (e.g. the HUD, the central console, or the digital dashboard) in the vehicle. Those notifications may be piled up until the driver manually selects to read one or more of them.

Additionally, regardless which display device is chosen to display the notifications, given the limited displayable area, it is feasibly impossible to display the entire messages/emails without shielding the important information, such as the current speed. In such circumstance, even notifications are promptly received, the driver could not know what he/she is being notified in a timely manner.

In the previous '785 application, the applicant has explained how to display contents on a different display device via various commands. Yet in the instant application, the same can be achieved through a simplifier approach.

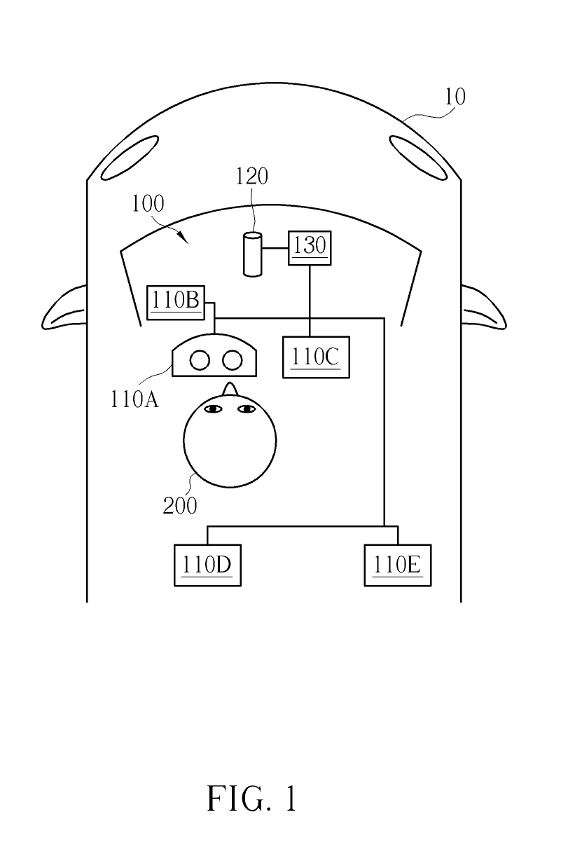

FIG. 1 is a schematic diagram of a multi-display control apparatus 100 according to an embodiment of the present disclosure. As shown, the multi-display control apparatus 100 includes display devices 110A-110E, a sensing module 120 and a control unit 130. In one embodiment, the display devices 110A-110E may be some sort of electronic devices capable of displaying contents and are disposed in a vehicle 10. For instance, they may include a digital dashboard 110A, a head-up display 110B, a central console display 110C, rear-seat displays 110D-110E. The types of the display devices 110A-110E mentioned above are only for illustrations, and the scope is not limited thereto.

The control unit 130 of the multi-display control apparatus 100 connects the display devices 110A-110E and controls contents to be displayed on one of, some of or all of the display devices 110A-110E. In one embodiment, the control unit 130 maybe an intelligent hardware device, such as a central processing unit (CPU), a micro-controller (MCU), or an ASIC. The control unit 130 may process data and instructions. In some embodiments, the control unit 130 is an automotive electronic control unit (ECU).

The sensing module 120 is configured to sense a gaze of a user 200. For example, the sensing module 120 may include an image capturing device for capturing a facial image or a hand image of the user 200. Additionally, the sensing module 120 may also include an image processing unit for determining a gaze of the user 200 based on parameters such as the user's eye and/or head positions. Moreover, given the positional change of the user's gaze at different times, the sensing module 120 can further determine the trace of gaze change of the user 200. In one embodiment, the trace of gaze change may be adopted to conclude where the intended content should be displayed. This will be discussed in detail in the later section.

The multi-display control apparatus 100 may also include a confirmation module (not shown in FIG. 1). The confirmation module is provided for the confirmation of the selection made by the user 200. The confirmation module may be a button, a knob, a joystick, a wheel, or a touch panel disposed on the steering wheel of the vehicle 10. In another embodiment, the confirmation may be given by a hand gesture, a facial motion, a head motion, a shoulder motion of a user 200. In some embodiments, the sensing module 120 may also serve to sense the confirmation command.

The idea of the present disclosure may be simplified as follows. Assuming the user 200 is driving a vehicle 10 and a notification is displayed on the predefined window of a primary display device to inform the user 200 that a messenger or an email is received. Under the operation of the present disclosure, the user 200 may look at the area where the notification displayed when he/she is available to do so and issues a confirmation command through the confirmation module to confirm the selection of the notification. Subsequently, the user 200 then decide the destination display device where he/she wants to read the subject content embedded by the notification. There are several ways to do this. First of all, it should be noted that the display device 110A-110E are fixtures to the vehicles 10, so their relevant positions are known to the multi-display control apparatus 100. That is, assuming the digital dashboard 110A is the primary display device where the received notification displayed. From its perspective, the head-up display 110B is in its upper side; while the central console display 110C is at the user's right hand side. Thus, if the user 200 decides to read the subject content from the head-up display 110B, he/she may give a move-upward instruction through the arrangement of the confirmation module. Similarly, if the user 200 wants the subject content to be displayed on the central console display 110C, he/she may issue a move-right instruction.

Alternatively, the movement may be achieved by following the change of the user's gaze. In reality, once the window of the notification is confirmed, the user 200 the user 200 may simply turns the eyesight toward to a destination display device for displaying the subject content. As discussed, the sensing module 120 is capable of tracking the trace of gaze change of the user 200. Following the above example, instead of giving a move-right instruction, the user 200 may look right and the subject content will then be displayed on the central console display 110C for the user 200 to read. Ideally, there should be no latency between the conclusion of the destination display device and the display of the subject content. That is, when the user's eyesight falls on the central console display 110C, the subject content should have been displayed thereon.

An additional confirmation command may be required from the user 200 to further confirm the selection of the destination display device. Alternatively, in yet another embodiment, the additional confirmation command may be skipped. That is, once either the moving direction is confirmed or the sensing module 120 determines that the user's current gaze has been on another display device for a certain period of time, the control unit 130 then displays the subject content on the destination display device.

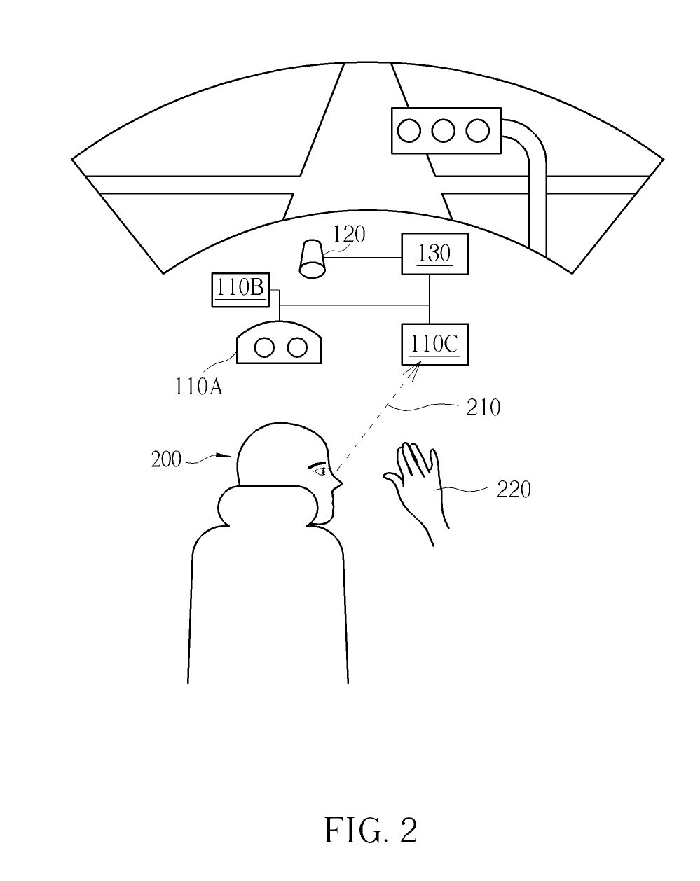

Please refer to FIG. 2, 3A and 3B. FIG. 2 is a schematic diagram illustrating the operation of the multi-display control apparatus 100 according to an embodiment of the present disclosure. In this embodiment, the multi-display control apparatus 100 includes a digital dashboard 110A, a head-up display 110B, and a central console display 110C. As mentioned previously, the positions of the digital dashboard 110A, the head-up display 110B, and the central console display 110C are known to the multi-display control apparatus 100. The positions may be referenced by a world coordinate system established in view of the objects within the vehicle 10. The establishment of a world coordinate system is a well-known practice to the skilled persons and will not be discussed in detail in the instant specification.

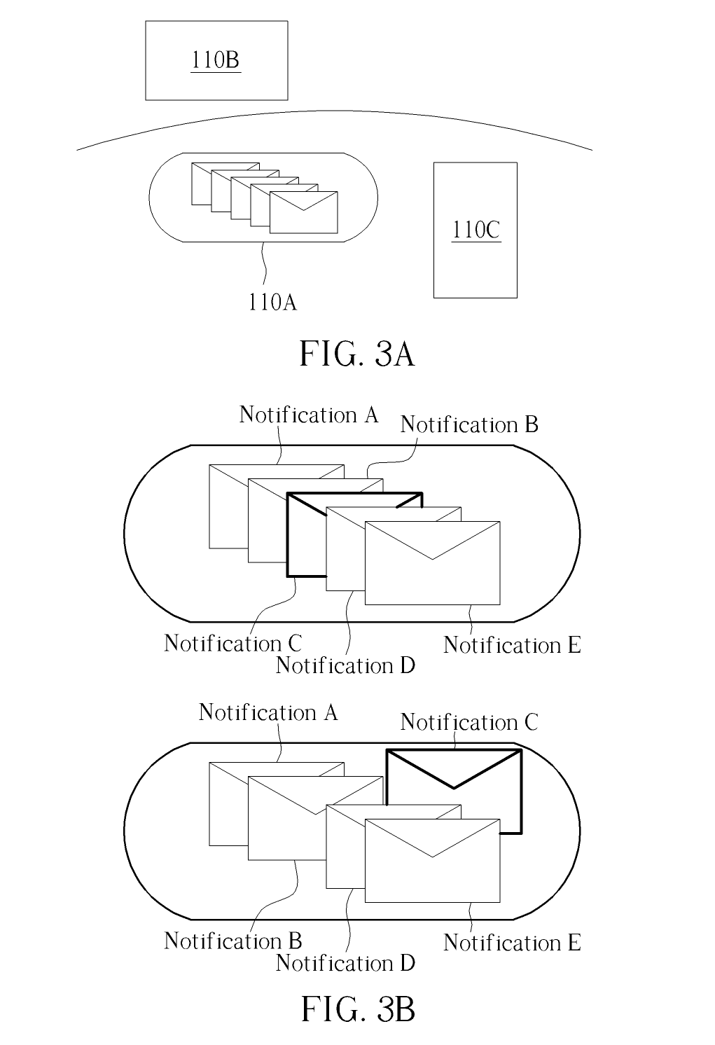

FIGS. 3A and 3B are schematic diagrams of the contents displayed on digital dashboard 110A according to an embodiment of the present disclosure. Assuming the digital dashboard 110A is the primary display device where notifications displayed. As shown in the FIG. 2, assuming the user 200 is driving the vehicle 10 and several notifications are prompted on the digital dashboard 110A and piled up. The user 200 then sweeps over the notifications. Under the operation of the present disclosure, the sensing module 120 determines if the user's eyesight falls on any particular notification based on the gaze of the user 200. The determination may be made through image processes by reference to the user's facial and/or head image. In brief, the sensing module 120 may determine the eye and/or head positions of the user 200 according to the captured facial and/or head images. Based on the positions, the sensing module 120 may further conclude the gaze of the user 200, particularly the point of interest, i.e. the point where the user 200 is looking at, the gaze direction as well as the gaze angle.

It should be noted that there could be some sort of indicator to highlight which notification that the user 200 stares at. For instance, as shown in FIGS. 3A and 3B, assuming there are five notifications piled up and shown on the digital dashboard 110A. Further, assuming it is determined by the sensing mold 120 that the user 200 is looking at the Notification 3, then there could be a frame or a light surrounding the Notification 3. Alternatively, the indicator could be in other forms, such as changing of the change, floating the selected window, etc. It should also be noted that there could other ways to highlight which notification is being looked by the user 200 based on his/her gaze. The above are mere examples and should under no circumstances become limitations to the present disclosure.

FIG. 3A depicts a schematic diagram of notifications piling up and displayed on a primary display device. In one instance, the primary display device is the digital dashboard 110A in the vehicle 10. As discussed, given the limited displayable size, the notifications are piled up. In the context of display, there are divisions arranged for various contents. Taking a digital dashboard, for the first layer, there maybe a division provided for the display of speedometer, another division for tachometer, and another for odometer. It would be understood by those skilled persons that the divisions are defined by templates, layouts and layers. Similarly, for notifications and texts, there may be other layers having numbers of divisions provided for them. That being said, the positions of notifications/texts on the primary display device are known to the multi-display control apparatus 110. By determining the point of interest based on the user's gaze, the apparatus 100 can compare the positions and conclude if the user 200 is looking at one particular notification. Further, although the term “notification” is described above, skilled persons should understand a notification is in fact a window that displays texts. The In the present disclosure, the multi-display control apparatus 100 may define the coordinates of each of the window that displays a notification. Upon which the multi-display control apparatus 100 can determine where the user gazes at.

Following the above example, once a notification window is highlighted (i.e. meaning the user 200 wants to read the content), the user 200 may issue a confirmation command through the confirmation module or other arrangements (such as a gesture, facial motions, etc.) discussed above to confirm the selection on the particular notification window. In one instance, upon the issuance of the confirmation command, the selected window may be locked.

Next, the sensing module 120 continuously tracks the user's eyesight to determine the destination location where the selected notification window and the subject content(s) should be displayed. From the user's perspective, the user 200 may simply move the eyesight onto one of the display devices where he/she intends to read the content. For example, the user 200 may choose to read the entire subject content delivered by the selected notification from the head-up display 110B. Alternatively, the user 200 may want the subject content to be displayed on the central console display 110C. Once the destination location is concluded, the control unit 130 controls the designated display device to display the content thereof. Additionally, the control unit 130 may magnify the font of the subject content for the user's easy reading.

Additionally, the selection of the destination location may otherwise be made through other means such as a cursor via a touch panel disposed on the steering wheel, a joystick, or directions buttons placed at the location where the user 200 can easily access.

With the design of the instant disclosure, the selected content may conveniently be displayed on another display device without additional commands. That is, when the confirmation command is issued, the selected content will be moved immediately after the destination display device is decided. Comparing to the previous application, the instance application is less complicated.

In some embodiments, the subject content may include navigation maps, texts, messages, emails, schedules, calendars, whether information, or vehicle data (e.g. the current speed, the current rotation speed, the accumulated miles, etc.). Additionally, the subject content may be information of the nature of sharing. It should be noted that the above are mere examples without intending to limit the instant disclosure in any aspects.

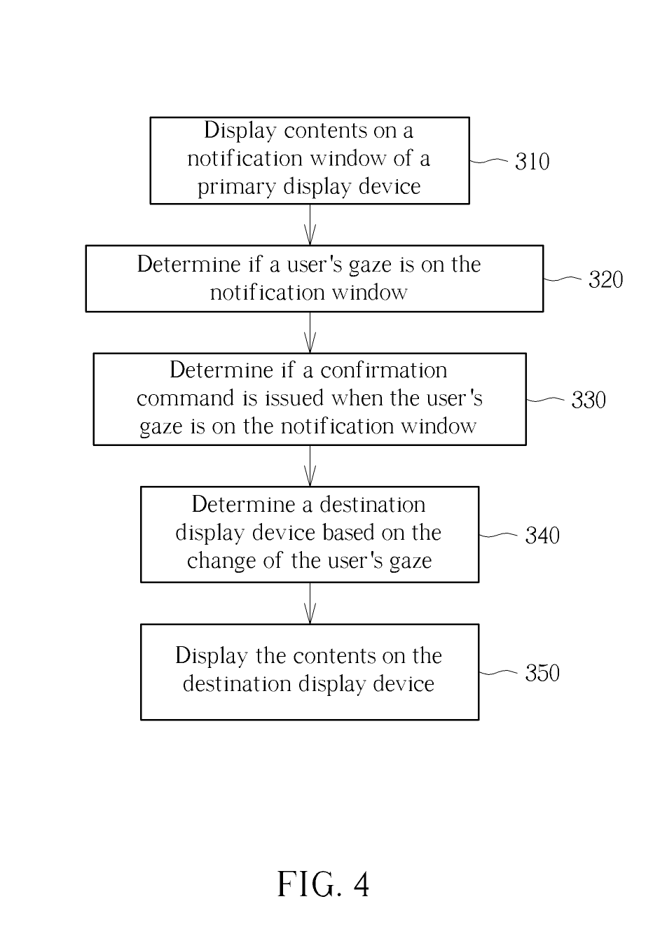

FIG. 4 is a flowchart 300 showing a method of displaying a subject content on multiple display devices according to an embodiment of the present disclosure. The method includes the following actions.

In action 310, display, by a control unit, contents on a notification window of a primary display device.

In action 320, determining, through a sensing module, if a user's gaze falls on the notification window.

In action 330, determining, through a confirmation module, if a confirmation command is issued when the user's gaze is on the notification window.

In action 340, determining, through the sensing module, a destination display device based on the change of the user's gaze.

In action 360, displaying, through a control unit, the contents on the destination display device.

Apart from the previous steps, the method of the present disclosure may include highlighting the notification window if it is determined by the sensing module that the user is looking at it. As previously discussed, there are many ways to highlight the notification window and the detail is skipped here.

It should be noted that the contents displayed on the notification window of the primary display device may be simple as a notification without the entire subject contents. Further, the location of the user's gaze may be determined through the following steps: obtaining the user's facial and/or head images to determine the eye and/or head positions; estimating the user's point of interest based on the relevant positions through some sort of machine learnings and/or deep learnings; and comparing the positions (e.g. the coordinates) of the notification window and the user's point of interest to conclude if the user's gaze falls on the notification window.

Moreover, as has been mentioned above, the confirmation module can be in various forms, such as a button or a touch panel, etc. disposed in the place where the user has convenient access to. For instance, the confirmation module may be disposed on the steering wheel.

In terms of the determination of the destination display device, aside from referring to the trace of the user's eyesight, a wheel, a touch panel, a joystick, or directional buttons may be adopted to choose the destination display device.

Lastly, when displaying the contents on the destination display device, the control unit may further adjust the size of the font so that the entire contents may be displayed on the destination display device. The adjustment may include fitting the entire contents to the size of the destination display device so that the user can easily read the entire contents without scrolling. It should be noted that such adjustment may involve magnifying or reducing the size of the font.

The multi-display control apparatus and the method of the present disclosure cause the selected content to be displayed on the user-chosen display device. Additionally, the size of the font may be adjusted allowing the entire content to be displayed on the destination display device without user's scrolling. Given the above, the present disclosure provides least distracting solution to instantly update the driver when he/she is driving a vehicle.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of displaying a subject content on multiple display devices, comprising:
displaying, by a control unit, a notification on a notification window of a primary display device, wherein the subject content is embedded in the notification;
determining, by a sensing module, if a user's gaze falls on the notification window;
determining, by a confirmation module, if a confirmation command is issued when the user's gaze is on the notification window;
determining, through the sensing module, a destination display device based on the change of the user's gaze; and
displaying, through the control unit, the subject content on the destination display device.

2. The method of claim 1, further comprising adjusting the font of the subject content to fit the size of the destination display device.

3. The method of claim 1, further comprising magnifying the font of the subject content to when the subject content is displayed on the destination display device.

4. The method of claim 1, wherein the destination display device is concluded by tracking the user's eyesight change through the operation of the sensing module.

5. The method of claim 1, further comprising:
obtaining a facial image of the user;
determining eye positions of the user based on the facial image;
calculating a point of interest of the user based on the user's eye positions; and
comparing the point of interest with the position of the notification window on the primary display device to conclude whether the user's gaze falls on the notification window.

6. The method of claim 1, further comprising highlighting the notification window when it is concluded the user's gaze is on the notification window.

7. The method of claim 1, wherein the primary display device is a digital dashboard of a vehicle; while the destination display device is either a head-up display or a central console display of the vehicle.

8. An apparatus for displaying a subject content to a user in a vehicle, comprising:
a digital dashboard disposed in the vehicle, wherein the digital dashboard has a notification window thereon for displaying a notification to inform the user of a receipt of the subject content; and
a destination display device also disposed in the vehicle, wherein, upon the user's selection, the destination display device is provided to display the subject content to the user;
wherein the font of the subject content is adjusted to fit the size of the destination display device.

9. The apparatus of claim 8, further comprising: a control unit electrically connected to the digital dashboard and the destination display device; the control unit is configured to display the notification on the notification window of the digital dashboard, and configured to display the subject content on the destination display device.

10. The apparatus of claim 9, further comprising: a sensing module electronically connected to the control unit and configured to determine a gaze of the user, wherein if the sensing module determines that the user's gaze is on the notification window, the control unit displays the subject content on the destination display device.

11. The apparatus of claim 10, wherein the sensing module tracks the change of user's gaze to conclude the destination display device.

12. The apparatus of claim 10, further comprising: a confirmation module configured to issue a confirmation module for the selection of the notification window.

13. The apparatus of claim 12, wherein the control unit further highlights the notification window to notify the selection of the notification window.

14. The apparatus of claim 8, wherein the destination display device is either a head-up display or a central console display in the vehicle.

15. A multi-display control apparatus for displaying a subject content to a user in a vehicle having a plurality of display devices, comprising:
a primary display device having a plurality of notification windows;
a destination display device;
a control unit configured to display a notification on one of the notification windows, wherein the subject content is embedded in the notification;
a sensing module configured to determine a gaze of the user; and
wherein the control unit displays the subject content on the destination display device if the user's gaze is on the notification window and the user then changes the gaze from the primary display device to the destination display device.

16. The multi-display control apparatus of claim 15, wherein the control unit further adjusts the size of the subject content to fit the size of the destination display device.

17. The multi-display control apparatus of claim 15, wherein the sensing module further tracks the change of the user's gaze to determine the location of the destination display device.

18. The multi-display control apparatus of claim 15, further comprising a confirmation module configured to issue a confirmation command, wherein the confirmation command is referred to confirm the selection of the notification window.

19. The multi-display control apparatus of claim 15, wherein the sensing module obtains a facial image of the user, determines the user's eye positions from the facial image, and calculates a point of interest based on the user's eye positions; wherein the sensing module conclude whether or not the user's gaze falls on the notification window by comparing the point of interest with the position of the notification window.

20. The multi-display control apparatus of claim 15, wherein the primary display device is a digital dashboard, while the destination display device is either a head-up display or a central console display in the vehicle.
